(19) United States
(12) Patent Application Publication
(10) Pub. No.: US 2015/0372709 A1
(43) Pub. Date: Dec. 24, 2015

(54) CONCURRENCY-MODE SCAN SCHEDULING FOR WIRELESS DEVICES

(71) Applicant: QUALCOMM Incorporated, San Diego, CA (US)

(72) Inventors: Ramachandran Ranganathan, Chennai (IN); Srinivasan Ganapathy, Chennai (IN); Suresh Kumar Nethirananthan, Chennai (IN); Manikandan Radhakrishnan, Chennai (IN); Vijayaraja Pitchaiah, Thanjavur (IN)

(21) Appl. No.: 14/313,860

(22) Filed: Jun. 24, 2014

(51) Int. Cl. H04B 1/401; H04W 48/16

(52) U.S. Cl. CPC H04B 1/401; H04W 48/16; H04W 88/06

(57) ABSTRACT

A wireless device operates as both a station and one or more access points. In the wireless device, a scan window of a specified duration is requested to start at a first time, to scan for access points external to the wireless device in accordance with operation of the wireless device as a station. It is determined that a beacon scheduled for transmission or reception at a second time conflicts with the requested scan window. In response, the beacon is transmitted or received at the second time and at least a portion of the scan window is delayed until after the beacon has been transmitted or received.

### TECHNICAL FIELD

The present embodiments relate generally to wireless communications, and specifically to wireless devices that operate in a concurrency mode as both an access point and a station in a wireless network.

### BACKGROUND OF RELATED ART

A wireless device (e.g., in a WiFi network or other wireless network) may concurrently operate as an access point (AP) and a station (STA). For example, the wireless device may operate as an AP for another nearby wireless device, while simultaneously acting as a STA that communicates with another AP. Such a wireless device is said to be operating in a concurrency mode (e.g., a STA-AP concurrency mode). Furthermore, a wireless device may operate as both a STA and two APs in a STA-AP-AP concurrency mode.

While acting as an AP, the wireless device periodically sends out beacon signals, referred to as beacons. While acting as a STA, the wireless device receives beacons from an AP to which it is connected and scans for other APs within range. Scanning, however, may conflict with scheduled beacon transmission and/or reception. Coordinating these actions in concurrency mode is challenging. If scanning is preempted in favor of beacon transmission and/or reception, the scan fail percentage (e.g., the probability that the scan will fail to identify an AP in range) increases. Performing scanning instead of transmitting and/or receiving beacons, however, can result in link disconnection.

Accordingly, there is a need for techniques to balance scanning and beacon scheduling in a wireless device in concurrency mode.

### SUMMARY

In some embodiments, a method of wireless communication is performed in a wireless device operating as both a station and one or more access points. In the method, a scan window of a specified duration is requested to start at a first time, to scan for access points external to the wireless device in accordance with operation of the wireless device as a station. It is determined that a beacon scheduled for transmission or reception at a second time conflicts with the requested scan window. In response, the beacon is transmitted or received at the second time and at least a portion of the scan window is delayed until after the beacon has been transmitted or received.

In some embodiments, a wireless device includes one or more antennas, a wireless modem to transmit and receive signals through the one or more antennas, one or more processors, and memory storing one or more programs configured for execution by the one or more processors. The one or more programs enable the wireless device to operate as both a station and one or more access points. The one or more programs include instructions to request that a scan window of a specified duration start at a first time, wherein the scan window is for scanning for access points external to the wireless device in accordance with operation of the wireless device as a station; instructions to determine whether a beacon scheduled for transmission or reception at a second time conflicts with the requested scan window; instructions to transmit or receive the beacon at the second time; and instructions to delay at least a portion of the scan window until after the beacon has been transmitted or received, if scheduling of the beacon at the second time conflicts with the requested scan window.

In some embodiments, a non-transitory computer-readable storage medium stores one or more programs configured for execution by one or more processors in a wireless device. The wireless device also includes one or more antennas and a wireless modem to transmit and receive signals through the one or more antennas. The wireless device is configurable to operate as both a station and one or more access points. The one or more programs include instructions to request that a scan window of a specified duration start at a first time, wherein the scan window is for scanning for access points external to the wireless device in accordance with operation of the wireless device as a station; instructions to determine whether a beacon scheduled for transmission or reception at a second time conflicts with the requested scan window; instructions to transmit or receive the beacon at the second time; and instructions to delay at least a portion of the scan window until after the beacon has been transmitted or received, if scheduling of the beacon at the second time conflicts with the requested scan window.

### BRIEF DESCRIPTION OF THE DRAWINGS

The present embodiments are illustrated by way of example and are not intended to be limited by the figures of the accompanying drawings.

FIGS. 1A and 1B are block diagrams of wireless networks in accordance with some embodiments.

FIGS. 2A and 2B show software and hardware elements for respective wireless devices in FIGS. 1A and 1B in accordance with some embodiments.

FIG. 3 is a timeline showing a schedule conflict between a requested scan window and a beacon in accordance with some embodiments.

FIG. 4 is a flowchart showing a method of scheduling a scan in accordance with some embodiments.

FIG. 5 is a timeline showing time slots for beacons on multiple channels, with a schedule conflict between a requested scan window and a beacon slot, in accordance with some embodiments.

FIG. 6 is a flowchart showing a method of scheduling a scan in accordance with some embodiments.

FIG. 7 is a flowchart of a method in which a predefined number of successive beacons are skipped in favor of scanning, in accordance with some embodiments.

FIG. 8 is a block diagram of a wireless device in accordance with some embodiments.

Like reference numerals refer to corresponding parts throughout the drawings and specification.

### DETAILED DESCRIPTION

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

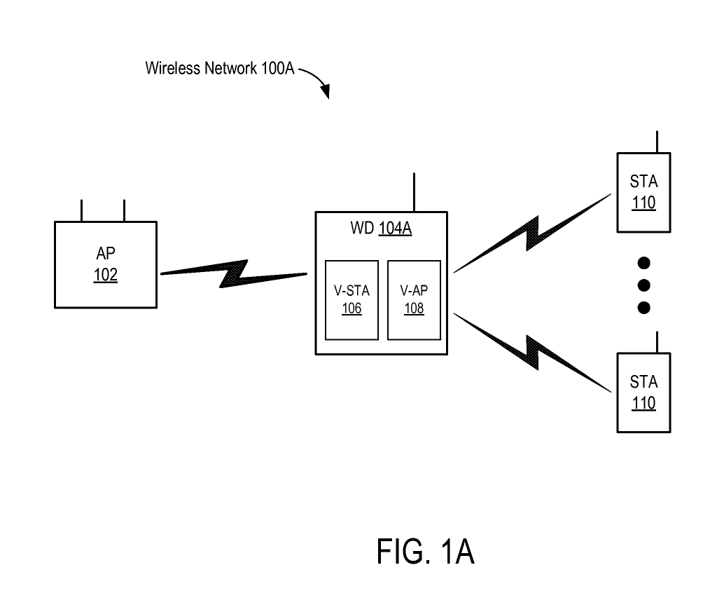

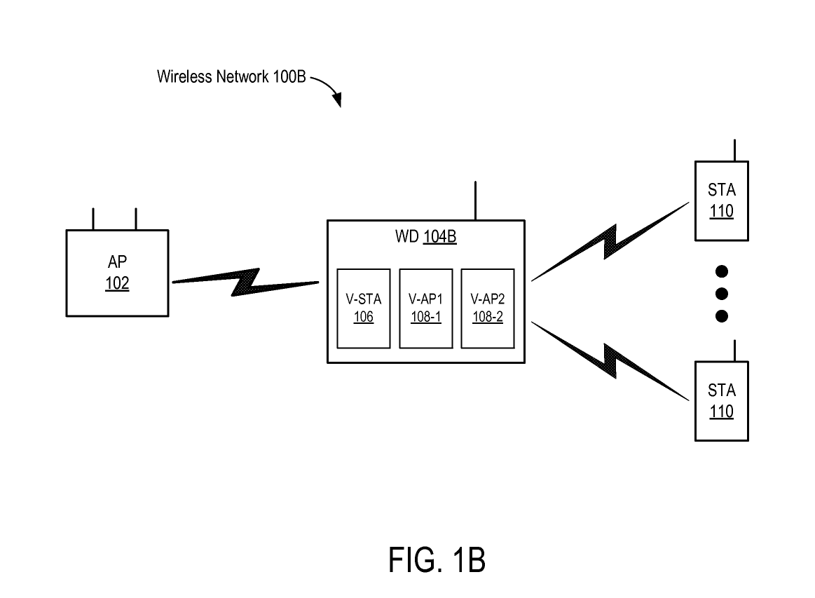

FIG. 1A is a block diagram of a wireless network 100A in accordance with some embodiments. The wireless network 100A includes an access point (AP) 102, a wireless device 104A, and one or more stations (STAs) 110. The wireless device 104A operates in a concurrency mode as both a STA and an AP. The concurrency mode may be referred to as a STA-AP concurrency mode. In the STA-AP concurrency mode, the wireless device 104A thus acts as both a virtual STA 106 and a virtual AP 108.

The virtual STA 106 in the wireless device 104A wirelessly connects to and communicates with the AP 102. In some embodiments, this wireless connection is a WiFi connection, in accordance with any of the IEEE 802.11 family of standards. The AP 102 provides the wireless device 104A with access to one or more networks beyond the wireless network 100A, and thus serves as a gateway to one or more wider networks. For example, the AP 102 may provide the wireless device 104A with access to a wide-area network (WAN), metropolitan-area network (MAN), campus network, and/or the Internet.

The virtual AP 108 in the wireless device 104A wirelessly connects to and communicates with the one or more STAs 110. In some embodiments, these wireless connections are also WiFi connections, in accordance with one or more standards in the IEEE 802.11 family of standards. Through these connections, the wireless device 104A gives the STAs 110 access to the AP 102 and any wider networks beyond the AP 102. The wireless device 104A thus shares its access to the AP 102 with the one or more STAs 110.

In its role as the virtual AP 108, the wireless device 104A periodically transmits beacons, which are received by the one or more stations 110. In its role as the virtual STA 106, the wireless device 104A periodically receives beacons transmitted by the AP 102. Beacons are used to establish and/or maintain wireless connections (i.e., wireless links) between respective devices. A beacon may include a traffic indication map (TIM) indicating whether downlink data is available. For example, a TIM in a beacon sent by the AP 102 may indicate whether the AP 102 has queued data for the wireless device 104A. A TIM in a beacon sent by the wireless device 104A (e.g., by the virtual AP 108) may indicate whether the wireless device 104A has queued data for any of the STAs 110. A beacon may also include timing synchronization information, such as a timing synchronization function (TSF) value. Beacons are transmitted according to a target beacon transmission time (TBTT) schedule. The wireless device 104A is aware of the TBTT schedule for the AP 102. The one or more STAs 110 are aware of the TBTT schedule for the virtual AP 108 in the wireless device 104A.

In its role as the virtual STA 106, the wireless device 104A also scans for APs (i.e., APs external to the wireless device 104A, as opposed to the virtual AP 108 in the wireless device 104A). Scanning is performed on a specified channel (e.g., a specified WiFi channel) during a scan window. This channel is referred to as the scan channel. Scanning may be active or passive. In active scanning, the virtual STA 106 transmits probe signals and listens for responses to the probe signals. A probe signal may be transmitted once at the beginning of a scan window or repeatedly (e.g., periodically) during the scan window. In passive scanning, the virtual STA 106 does not transmit probe signals, but merely listens for signals from external APs. In some embodiments, the virtual STA 106 may perform normal scans, connect scans, and/or roam scans, each of which may be active or passive. In a normal scan, the virtual STA 106 scans for available APs, and thus for hot-spots associated with available APs, and updates a table of available APs (e.g., its roaming table) accordingly, without deciding whether to connect to a particular AP. In a connect scan, the virtual STA 106 has identified an external AP to connect to and performs a scan as part of the connection process. In a roam scan, the virtual STA 106 is connected to a first external AP (e.g., the AP 102) but scans for other APs to which it might connect (e.g., because it is losing its connection to the first AP).

FIG. 1B is a block diagram of a wireless network 100B in accordance with some embodiments. The wireless network 100B includes the AP 102, a wireless device 104B, and one or more STAs 110. The wireless device 104B operates in a concurrency mode as a STA and as two APs. This concurrency mode may be referred to as a STA-AP-AP concurrency mode. In the STA-AP-AP concurrency mode, the wireless device 104B thus acts as a virtual STA 106, a first virtual AP 108-1, and a second virtual AP 108-2. The first virtual AP 108-1 operates on a first frequency band (e.g., 2.4 GHz) and the second virtual AP 108-2 operates on a second frequency band (e.g., 5 GHz). The wireless device 104B periodically transmits beacons in its role as each of the first and second virtual APs 108-1 and 108-2. The wireless device 104B scans for APs and receives beacons in its role as the virtual STA 106, as described with respect to FIG. 1A.

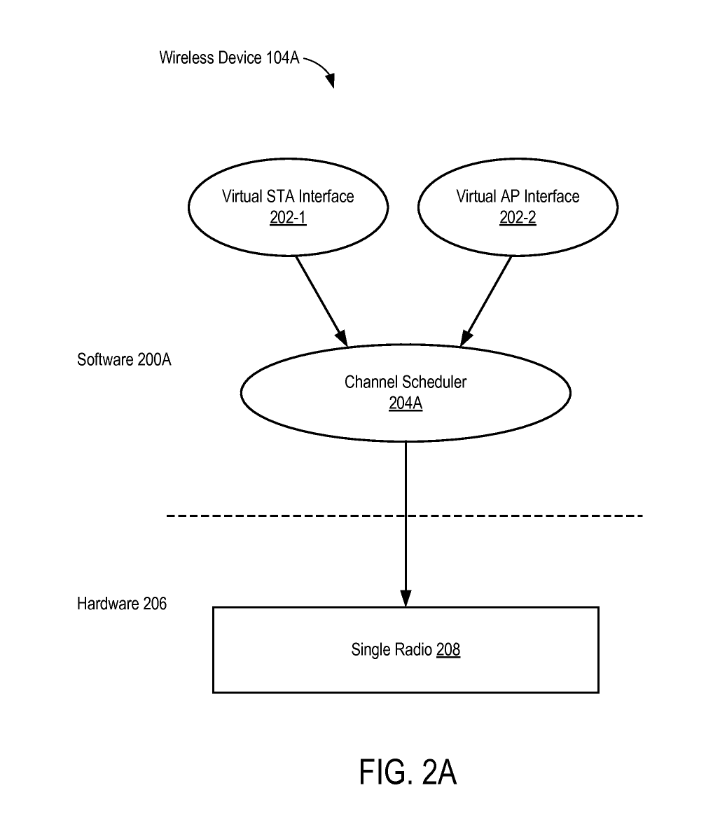

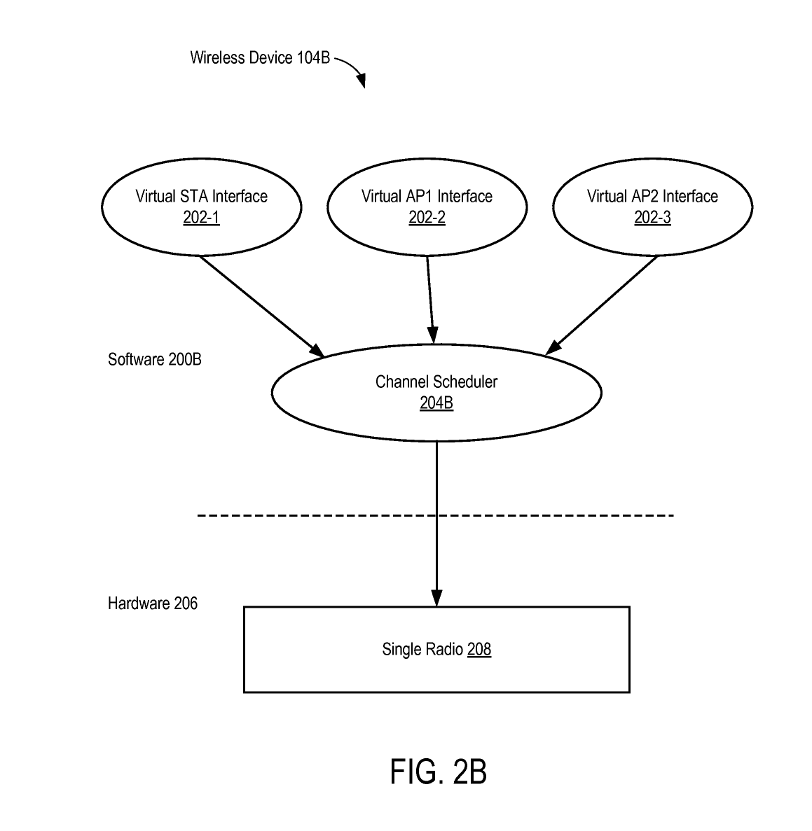

FIG. 2A shows software and hardware elements for the wireless device 104A (FIG. 1A) in accordance with some embodiments. Software 200A in the wireless device 104A includes a virtual STA interface 202-1 for the virtual STA 106 (FIG. 1A), a virtual AP interface 202-2 for the virtual AP 108 (FIG. 1A), and a channel scheduler 204A. Hardware 206 in the wireless device 104A includes a single radio 208. The virtual STA interface 202-1 and virtual AP interface 202-2 connect to the radio 208 through the channel scheduler 204A.

FIG. 2B shows software and hardware elements for the wireless device 104B (FIG. 1B) in accordance with some embodiments. Software 200B in the wireless device 104B includes a virtual STA interface 202-1 for the virtual STA 106 (FIG. 1B), a first virtual AP interface 202-2 for the virtual AP 108-1 (FIG. 1B), a second virtual AP interface 202-3 for the virtual AP 108-2 (FIG. 1B), and a channel scheduler 204B. Hardware 206 in the wireless device 104B includes the single radio 208. The virtual STA interface 202-1, first virtual AP interface 202-2, and second virtual AP interface 202-3 connect to the radio 208 through the channel scheduler 204B.

The wireless devices 104A (FIG. 1A) and 104B (FIG. 1B) thus may be configured with multiple interfaces that use a single media access controller (MAC) and single radio.

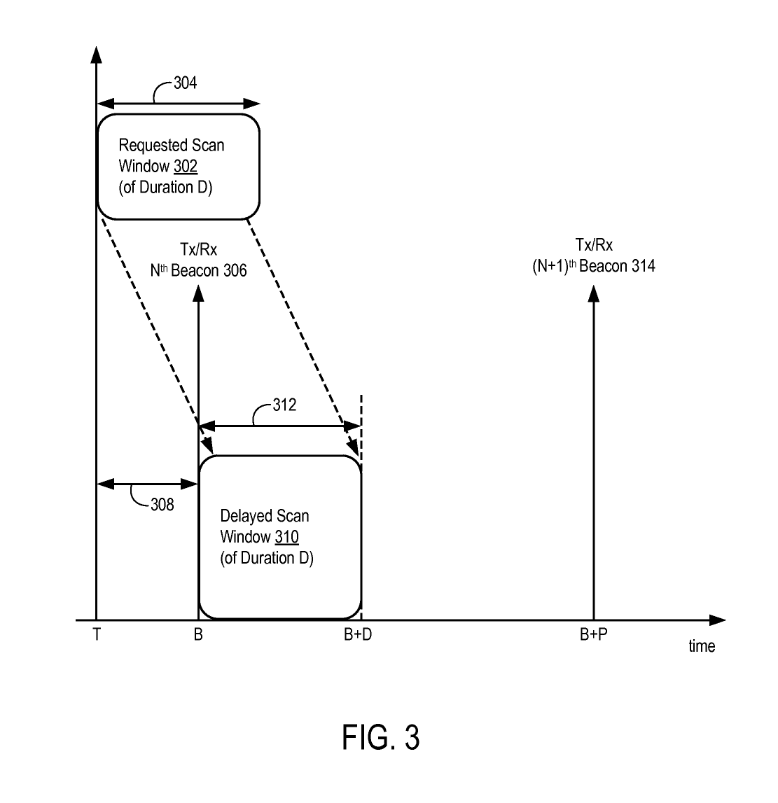

FIG. 3 is a timeline showing a schedule conflict between a requested scan window 302 and a beacon 306 in accordance with some embodiments. In some embodiments, the timeline of FIG. 3 applies to the wireless device 104A (FIGS. 1A, 2A) when operating in a same-channel concurrency mode, with the virtual STA 106 and the virtual AP 108 using the same channel, referred to as a home channel. The beacon 306 is one of a series of beacons scheduled for transmission (e.g., by the virtual AP 108) or reception (e.g., by the virtual STA 106) with a period P. The beacon 306 is scheduled for transmission or reception at a time B. For example, the time B is a Targeted Beacon Transmit Time (TBTT) at which the virtual AP 108 is scheduled to transmit the beacon 306 or at which the virtual STA 106 is scheduled to receive the beacon 306. A subsequent beacon 314 is scheduled for transmission or reception at a time B+P. For example, the time B+P is another TBTT.

The virtual STA interface 202-1 (FIG. 2A) requests that a scan window 302 of duration D begin at a time T on a scan channel distinct from the home channel. The requested scan window thus would occupy a time period 304 from T to T+D. The virtual STA interface 202-1 (FIG. 2A) can make this request at any point in time, regardless of other scheduled activity. The channel scheduler 204A determines that the requested scan window 302 conflicts with the beacon 306.

The channel scheduler 204A could allow scanning to begin at time T and abort the scan before the beacon 306 is transmitted at time B. Scanning thus would occur during the time period 308, which has a duration less than D. Aborting the scan, however, would increase the scan fail percentage (e.g., the probability that the scan will fail to identify an AP in range). Or the channel scheduler 204A could preempt transmission or reception of the beacon 306 in favor of scanning during the requested scan window 302. Preempting transmission or reception of the beacon 306, however, could result in link disconnection.

Instead, the requested scan window 302 is delayed until after the beacon is transmitted or received at time B. Scanning thus occurs in a delayed scan window 310 of duration D, in a time period 312 that starts after time B and ends at time B+D. The scan thus is not preempted by the beacon 306, allowing the virtual STA 106 to spend more time (i.e., to dwell longer) on the scan channel, thus improving scan findings.

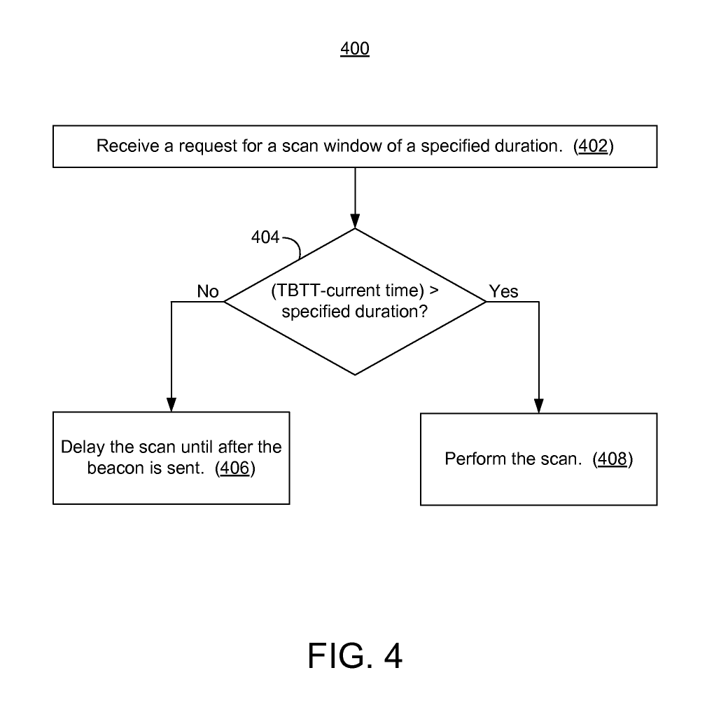

FIG. 4 is a flowchart showing a method 400 of scheduling a scan in accordance with some embodiments. The method 400 illustrates the logic behind the timeline of FIG. 3 and is performed, for example, by the wireless device 104A (FIGS. 1A and 2A). In the method 400, the channel scheduler 204A (FIG. 2A) receives (402) a request for a scan window of a specified duration (e.g., for the requested scan window 302, FIG. 3). The channel scheduler 204A determines (404) whether the next TBTT minus the current time (or the time at which the scan window is requested to begin) is greater than the specified duration. If so (404-Yes), then the requested scan window does not conflict with the TBTT, and the scan is performed (408) in the requested scan window. If not (404—No), then the requested scan window conflicts with the TBTT. The scan is delayed (406) until the beacon is sent (or received). The scan is then performed in the delayed scan window (e.g., delayed scan window 310, FIG. 3).

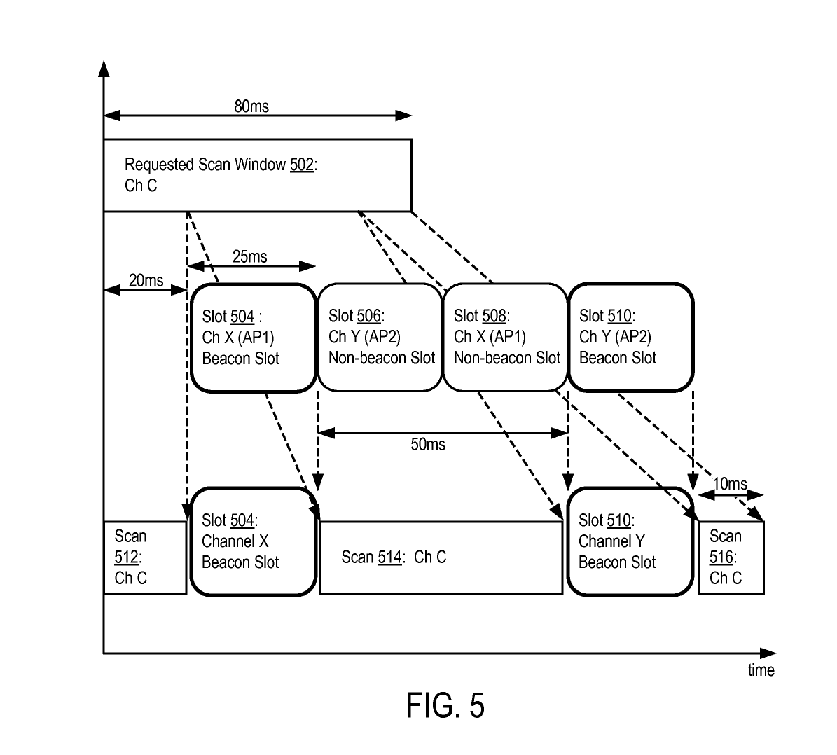

FIG. 5 is a timeline showing time slots for beacons on multiple channels, with a schedule conflict between a requested scan window 502 and a beacon slot 504, in accordance with some embodiments. In some embodiments, the timeline of FIG. 5 applies to the wireless device 104B (FIGS. 1B, 2B) when operating in a multi-channel concurrency mode. In the multi-channel concurrency mode, the first virtual AP 108-1 uses a first channel (channel X), the second virtual AP 108-2 uses a second channel (channel Y), and the scan window 502 is requested for a third channel (channel C). The virtual STA 106 may use channel X, channel Y, or another channel. Channel X and channel Y are both home channels, while channel C is the scan channel.

A series of time slots 504, 506, 508, and 510 are scheduled for allocation to the first and second virtual APs 108-1 and 108-2 in an alternating manner. Slot 504 is allocated for transmission or reception of a beacon on channel X by the first virtual AP 108-1, while slot 510 is allocated for transmission or reception of a beacon on channel Y by the second virtual AP 108-2. Slots 506 and 508 are non-beacon slots allocated for other uses besides beacon transmission or reception. Each of the slots 504, 506, 508, and 510 has a duration of 25 ms. (The various durations shown in FIG. 5 are merely examples and may vary.) The beacon slots 504 and 510 thus are separated by 50 ms. The time interval between beacons is shorter for multi-channel concurrency than for single-channel concurrency, because in multi-channel concurrency beacons are transmitted and/or received on multiple home channels, whereas in single-channel concurrency beacons are transmitted and received on a single channel.

The requested scan window 502, with a duration of 80 ms, is requested 20 ms before the beginning of the beacon slot 504. The requested scan window 502 therefore conflicts with the beacon slot 504. Furthermore, the 80 ms duration of the requested scan window 502 is greater than the 50 ms time interval between beacon slots, making a conflict inevitable. The channel scheduler 204B could allow the scan on channel C to start as requested, but then preempt the scan and switch to channel X to honor the beacon slot 504. This preemption would reduce the scan's effectiveness, however: the scan's effectiveness is proportional to its duration.

To address these challenges, the requested scan window 502 is divided into multiple portions 512, 514, and 516 that are separated by the beacon slots 504 and 510. The portion 512, which is 20 ms, begins at the requested time (e.g., the current time) and continues until the beginning of the beacon slot 504. The portion 514, which is 50 ms, begins after the beacon slot 504 and ends before the beacon slot 510. The portion 514 thus preempts the non-beacon slots 506 and 508: this time period is used to scan on channel C and not to communicate on channels X and Y. (The portions 512 and 516 may similarly preempt non-beacon slots, which are not shown for simplicity). The portion 516, which is 10 ms, begins after the beacon slot 510. Scanning is performed on channel C during each of the portions 512, 514, and 516: during each of these periods, the wireless device 104B dwells on channel C for the scan. The portions 512, 514, and 516 taken together have a total duration equal to the duration of the requested scan window 502. The split-window technique of FIG. 5 improves scan results compared to preemption, because scanning occurs for a duration equal to the duration of the requested scan window 502.

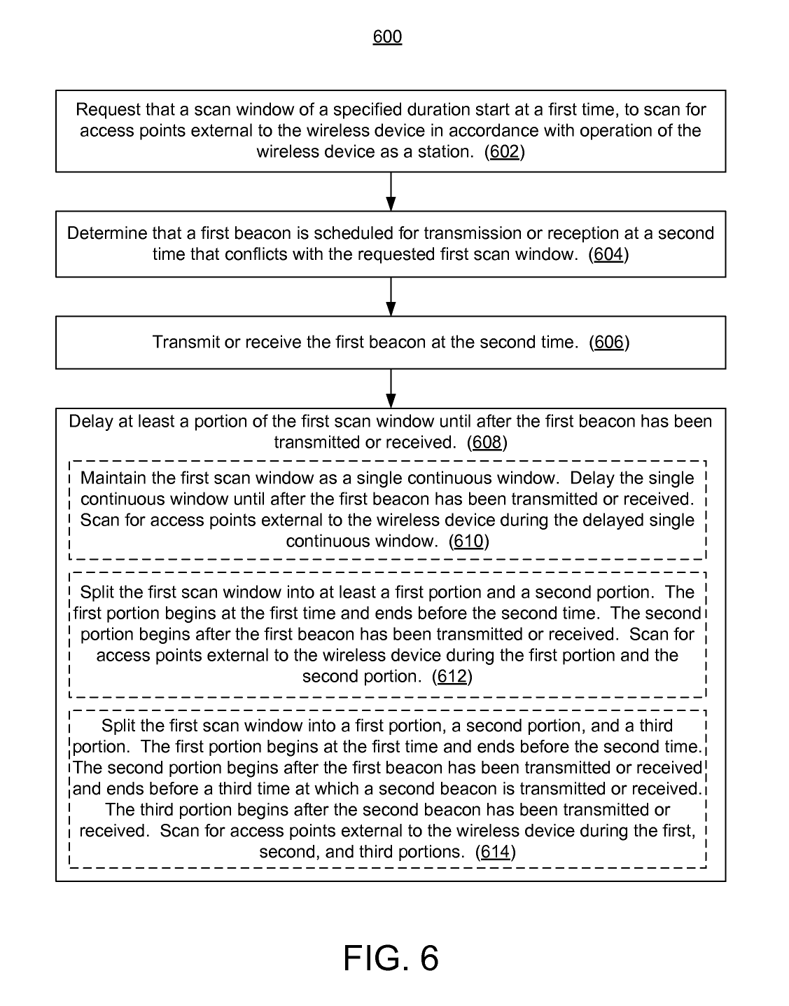

FIG. 6 is a flowchart showing a method 600 of scheduling a scan in accordance with some embodiments. The method 600 is performed in a wireless device operating in a concurrency mode as both a STA and one or more APs. For example, the method is performed by the wireless device 104A (FIGS. 1A and 2A) or 104B (FIGS. 1B and 2B).

In the method 600, a scan window (e.g., requested scan window 302, FIG. 3; requested scan window 502, FIG. 5) of a specified duration is requested (602) to start at a first time, to scan for APs external to the wireless device in accordance with operation of the wireless device as a STA. The requested scan window is determined (604) to conflict with a first beacon (e.g., beacon 306, FIG. 3; a beacon in beacon slot 504, FIG. 5) scheduled for transmission at a second time. For example, it is determined that a TBTT conflicts with the requested scan window (e.g., determination 404—No, FIG. 4).

The first beacon is transmitted or received (606) at the second time (e.g., at the TBTT). At least a portion of the first scan window is delayed (608) until after the first beacon has been transmitted or received (e.g., until after the TBTT).

In some embodiments, the first scan window is maintained (610) as a single continuous window and delayed until after the first beacon has been transmitted or received (e.g., resulting in delayed scan window 310, FIG. 3). Scanning for APs external to the wireless device is performed during the delayed single continuous window.

In some embodiments, the first scan window is split (612) into at least a first portion and a second portion. The first portion begins at the first time and ends before the second time. The second portion begins after the first beacon has been transmitted or received. Scanning for APs external to the wireless device is performed during the first portion and again during the second portion.

In some embodiments, the first scan window is split (614) into a first portion (e.g., portion 512, FIG. 5), a second portion (e.g., portion 514, FIG. 5), and a third portion (e.g., portion 516, FIG. 5). The first portion begins at the first time and ends before the second time. The second portion begins after the first beacon has been transmitted or received and ends before a third time at which a second beacon is transmitted or received. The third portion begins after the second beacon has been transmitted or received. Scanning for APs external to the wireless device is performed during each of the first, second, and third portions.

In some embodiments (e.g., in the example of FIG. 5), the first scan window is split into portions in the operation 612 or 614 because the specified duration of the requested scan window is longer than the time between successive beacons.

Scanning is performed on a scan channel that is distinct from the home channel(s) of the wireless device.

The method 600 may be repeated for multiple scan windows. If a respective scan window, as requested, is determined not to conflict with a scheduled beacon, then scanning for APs external to the wireless device is performed during the respective scan window (e.g., in operation 408, FIG. 4), without delaying or splitting the respective scan window.

At times it may be desirable to give scanning priority over scheduled beacons (e.g., over AP beacon transmission), thus allowing channel dwells for scanning to be continuous without interruption by beacon transmission (or reception). For example, it may be desirable to give scanning priority over TBTTs when performing connect or roam scans. However, repeated skipping of beacon transmission (or reception) will eventually result in link disconnection.

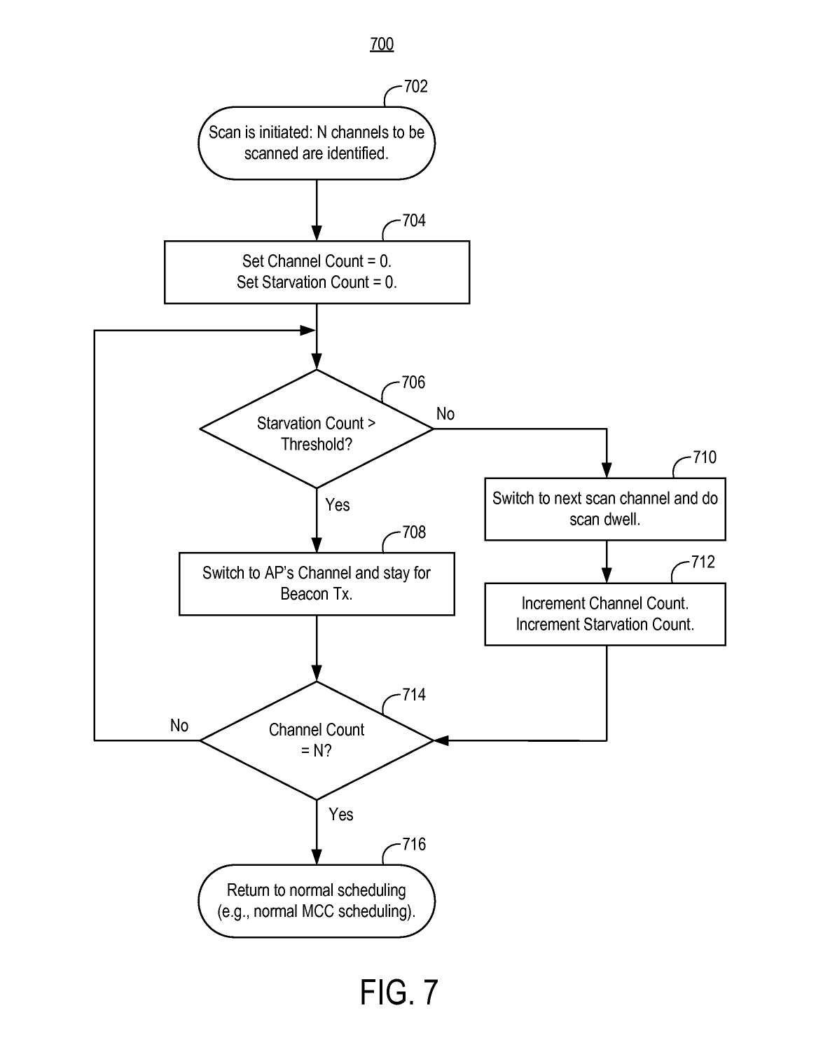

FIG. 7 is a flowchart of a method 700 in which a predefined number of successive beacons are skipped, and thus preempted, in favor of scanning, in accordance with some embodiments. The method 700 is performed, for example, in the wireless device 104A (FIGS. 1A and 2A) or 104B (FIGS. 1B and 2B), with the logic of the method 700 being implemented in the channel scheduler 204A or 204B (FIG. 2A or 2B). In some embodiments, the method 700 is performed for connect and/or roam scans. In the method 700, the number of skipped beacons is referred to as the starvation count. The virtual STA 106 effectively hijacks the wireless device 104A or 104B for scanning until the starvation count satisfies a threshold.

The scanning process of the method 700 is initiated (702) by identifying N channels on which scanning is to be performed, where N is an integer greater than or equal to one. A channel count is set (704) to zero and the starvation count is set to zero.

The method 700 then enters a loop. The starvation count is compared (706) to the threshold. If the starvation count does not satisfy the threshold (706—No) (e.g., is less than or equal to the threshold, or is less than the threshold), then the wireless device 104A or 104B switches (710) to the next identified scan channel and dwells on the channel to scan for external APs. The channel count and starvation count are incremented (712). The wireless device 104A or 104B thus suppresses transmission (or reception) of a beacon on each iteration through this branch of the loop. (It is assumed in the example of FIG. 7 that scanning on each identified channel does not exceed the period between beacons. But in other examples, this assumption may not hold, and incrementing of the starvation count is adjusted accordingly.)

If the starvation count satisfies the threshold (706-Yes) (e.g., is greater than the threshold, or greater than or equal to the threshold), then the wireless device 104A or 104B switches to the channel on which the next beacon is scheduled and transmits (or alternatively, receives) the next beacon. The wireless device 104A or 104B thus halts the scanning to transmit (or receive) a beacon. For example, the wireless device 104A switches to the channel used by the virtual AP 108 and transmits a beacon at the next TBTT. In another example, the wireless device 104B switches to the channel used by one of the virtual APs 108-1 and 108-2 and transmits a beacon at the next TBTT.

The channel count is compared (714) to N. If the channel count is less than N (714—No), then there are more channels to be scanned, and the execution of the method 700 returns to operation 706. If the channel count equals N, then there are no more channels to be scanned, and the channel scheduler 204A or 204B (FIG. 2A or 2B) returns to normal scheduling (e.g., to normal multi-channel concurrency (MCC) scanning).

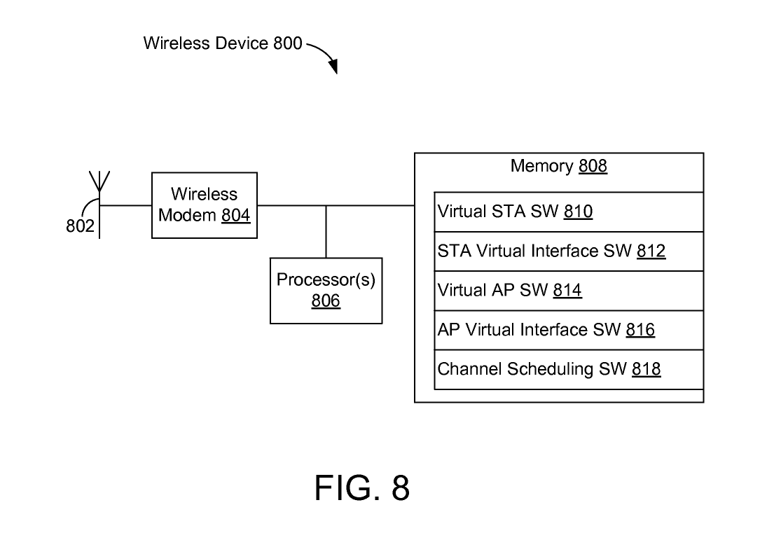

FIG. 8 is a block diagram of a wireless device 800 in accordance with some embodiments. The wireless device 800 is an example of a wireless device 104A (FIGS. 1A and 2A) or 104B (FIGS. 1B and 2B). The wireless device 800 includes one or more antennas 802 coupled to a wireless modem 804 that transmits and receives signals through the one or more antennas 802. The wireless device 800 also includes memory 808 and one or more processors 806. The memory 808 stores one or more programs with instructions configured for execution by the one or more processors 806. The one or more programs may be stored in a non-transitory computer-readable storage medium (e.g., non-volatile memory) in the memory 808.

The one or more programs include software 810 for implementing a virtual STA 106 (FIGS. 1A and 1B) and software 812 for implementing a corresponding virtual STA interface 202-1 (FIGS. 2A and 2B). The one or more programs also include software 814 for implementing the virtual AP 108 (FIG. 1A) or the virtual APs 108-1 and 108-2 (FIG. 1B) and software for implementing one or more corresponding virtual AP interfaces 202-2 and/or 202-3 (FIGS. 2A and 2B). The one or more programs further include channel-scheduling software 818 for implementing a channel scheduler 204A (FIG. 2A) or 204B (FIG. 2B). Accordingly, the memory 808 may include instructions on a non-transitory computer-readable storage medium for performing all or a portion of the methods 400 (FIG. 4), 600 (FIG. 6), and/or 700 (FIG. 7).

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method of wireless communication, comprising:
in a wireless device operating as both a station and one or more access points:
requesting that a first scan window of a specified duration starts at a first time, to scan for access points external to the wireless device in accordance with operation of the wireless device as a station;
determining that a first beacon is scheduled for transmission or reception at a second time that conflicts with the requested first scan window;
transmitting or receiving the first beacon at the second time; and
delaying at least a portion of the first scan window until after the first beacon has been transmitted or received.

2. The method of claim 1, wherein the delaying comprises:
maintaining the first scan window as a single continuous window; and
delaying the single continuous window until after the first beacon has been transmitted or received;
wherein the method further comprises scanning for access points external to the wireless device during the delayed single continuous window.

3. The method of claim 2, wherein:
the determining comprises determining that a targeted beacon transmit time (TBTT) conflicts with the requested first scan window;
transmitting or receiving the first beacon comprises transmitting the first beacon at the TBTT in accordance with operation of the wireless device as an access point; and
delaying the single continuous window comprises delaying the single continuous window until after the TBTT.

4. The method of claim 3, wherein:
the wireless device operates on a first channel as both a station and an access point; and
the scanning is performed on a second channel distinct from the first channel.

5. The method of claim 2, further comprising:
in accordance with operation of the wireless device as a station, requesting that a second scan window of a specified duration start at a third time, to scan for access points external to the wireless device;
determining that the requested second scan window does not conflict with a scheduled beacon; and
scanning for access points external to the wireless device during the requested second scan window starting at the third time.

6. The method of claim 5, wherein:
determining that the first beacon is scheduled for transmission or reception at a time that conflicts with the requested first scan window comprises determining that the requested first scan window conflicts with a TBTT; and
determining that the requested second scan window does not conflict with a scheduled beacon comprises determining that the requested second scan window does not conflict with a TBTT.

7. The method of claim 1, wherein the delaying comprises splitting the first scan window into at least a first portion and a second portion, the first portion beginning at the first time and ending before the second time, the second portion beginning after the first beacon has been transmitted or received.

8. The method of claim 7, wherein the method further comprises scanning for access points external to the wireless device during the first portion and the second portion.

9. The method of claim 7, wherein the splitting is responsive to the specified duration being longer than a time between successive beacons.

10. The method of claim 7, wherein:
the method further comprises transmitting or receiving a second beacon at a third time;
the delaying comprises splitting the first scan window into the first portion, the second portion, and a third portion, the second portion ending before the third time, the third portion beginning after the second beacon has been transmitted or received; and
the method further comprises scanning for access points external to the wireless device during the first portion, the second portion, and the third portion.

11. The method of claim 10, wherein:
the first beacon is transmitted or received on a first channel;
the second beacon is transmitted or received on a second channel distinct from the first channel; and
the scanning is performed on a third channel distinct from the first and second channels.

12. The method of claim 1, further comprising:
transmitting beacons, in accordance with operation of the wireless device as one or more access points;
scanning for access points external to the wireless device, in accordance with operation of the wireless device as a station;
while scanning, suppressing transmission of beacons;
counting a number of suppressed beacons; and
in response to the number of suppressed beacons satisfying a threshold, halting the scanning and transmitting a beacon.

13. The method of claim 1, wherein halting the scanning and transmitting the beacon comprise switching from a first channel on which scanning is performed to a second channel on which the beacon is to be transmitted.

14. The method of claim 1, wherein the scanning comprises scanning for access points on multiple channels.

15. A wireless device, comprising:
one or more antennas;
a wireless modem to transmit and receive signals through the one or more antennas;
one or more processors; and
memory storing one or more programs configured for execution by the one or more processors to enable the wireless device to operate as both a station and one or more access points, the one or more programs comprising:
instructions to request that a first scan window of a specified duration start at a first time, wherein the first scan window is for scanning for access points external to the wireless device in accordance with operation of the wireless device as a station;
instructions to determine whether a first beacon scheduled for transmission or reception at a second time conflicts with the requested first scan window;
instructions to transmit or receive the first beacon at the second time; and
instructions to delay at least a portion of the first scan window until after the first beacon has been transmitted or received, if scheduling of the first beacon at the second time conflicts with the requested first scan window.

16. The wireless device of claim 15, wherein:
the instructions to delay comprise instructions to maintain the first scan window as a single continuous window and to delay the single continuous window until after the first beacon has been transmitted or received; and
the one or more programs further comprise instructions to scan for access points external to the wireless device during the delayed single continuous window.

17. The wireless device of claim 16, wherein:
the instructions to determine comprise instructions to determine that a targeted beacon transmit time (TBTT) conflicts with the requested first scan window;
the instructions to transmit or receive comprise instructions to transmit the first beacon at the TBTT, in accordance with operation of the wireless device as an access point; and
the instructions to delay comprise instructions to delay the single continuous window until after the TBTT.

18. The wireless device of claim 15, wherein the instructions to delay comprise instructions to split the first scan window into at least a first portion and a second portion, the first portion beginning at the first time and ending before the second time, the second portion beginning after the first beacon has been transmitted or received.

19. The wireless device of claim 18, wherein:
the one or more programs further comprise instructions to transmit or receive a second beacon at a third time;
the instructions to split comprise instructions to split the first scan window into the first portion, the second portion, and a third portion, the second portion ending before the third time, the third portion beginning after the second beacon has been transmitted or received; and
the one or more programs further comprise instructions to scan for access points external to the wireless device during the first portion, the second portion, and the third portion.

20. The wireless device of claim 15, the one or more programs further comprising:
instructions to transmit beacons, in accordance with operation of the wireless device as one or more access points;
instructions to scan for access points external to the wireless device, in accordance with operation of the wireless device as a station;
instructions to suppress transmission of beacons while scanning;
instructions to count a number of suppressed beacons; and
instructions to halt the scanning and to transmit a beacon, in response to the number of suppressed beacons satisfying a threshold.

21. A non-transitory computer-readable storage medium storing one or more programs configured for execution by one or more processors in a wireless device that also comprises one or more antennas and a wireless modem to transmit and receive signals through the one or more antennas, the wireless device being configurable to operate as both a station and one or more access points, the one or more programs comprising:
instructions to request that a first scan window of a specified duration start at a first time, wherein the first scan window is for scanning for access points external to the wireless device in accordance with operation of the wireless device as a station;
instructions to determine whether a first beacon scheduled for transmission or reception at a second time conflicts with the requested first scan window;
instructions to transmit or receive the first beacon at the second time; and
instructions to delay at least a portion of the first scan window until after the first beacon has been transmitted or received, if scheduling of the first beacon at the second time conflicts with the requested first scan window.

22. The computer-readable storage medium of claim 21, wherein:
the instructions to delay comprise instructions to maintain the first scan window as a single continuous window and to delay the single continuous window until after the first beacon has been transmitted or received; and
the one or more programs further comprise instructions to scan for access points external to the wireless device during the delayed single continuous window.

23. The computer-readable storage medium of claim 22, wherein:
the instructions to determine comprise instructions to determine that a targeted beacon transmit time (TBTT) conflicts with the requested first scan window;
the instructions to transmit or receive comprise instructions to transmit the first beacon at the TBTT, in accordance with operation of the wireless device as an access point; and
the instructions to delay comprise instructions to delay the single continuous window until after the TBTT.

24. The computer-readable storage medium of claim 21, wherein the instructions to delay comprise instructions to split the first scan window into at least a first portion and a second portion, the first portion beginning at the first time and ending before the second time, the second portion beginning after the first beacon has been transmitted or received.

25. The computer-readable storage medium of claim 24, wherein:
the one or more programs further comprise instructions to transmit or receive a second beacon at a third time;
the instructions to split comprise instructions to split the first scan window into the first portion, the second portion, and a third portion, the second portion ending before the third time, the third portion beginning after the second beacon has been transmitted or received; and
the one or more programs further comprise instructions to scan for access points external to the wireless device during the first portion, the second portion, and the third portion.

26. The computer-readable storage medium of claim 21, the one or more programs further comprising:
instructions to transmit beacons, in accordance with operation of the wireless device as one or more access points;
instructions to scan for access points external to the wireless device, in accordance with operation of the wireless device as a station;
instructions to suppress transmission of beacons while scanning;
instructions to count a number of suppressed beacons; and
instructions to halt the scanning and to transmit a beacon, in response to the number of suppressed beacons satisfying a threshold.

27. A wireless device, comprising:
means for requesting that a first scan window of a specified duration start at a first time, to scan for access points external to the wireless device;
means for determining that a first beacon is scheduled for transmission or reception at a second time that conflicts with the requested first scan window;
means for transmitting or receiving the first beacon at the second time; and
means for delaying at least a portion of the first scan window until after the first beacon has been transmitted or received.

28. The wireless device of claim 27, wherein:
the means for delaying comprise means for maintaining the first scan window as a single continuous window and for delaying the single continuous window until after the first beacon has been transmitted or received; and
the wireless device further comprises means for scanning for access points external to the wireless device during the delayed single continuous window.

29. The wireless device of claim 27, wherein the means for delaying comprise means for splitting the first scan window into at least a first portion and a second portion, the first portion beginning at the first time and ending before the second time, the second portion beginning after the first beacon has been transmitted or received.

30. The wireless device of claim 27, comprising:
means for transmitting beacons;
means for scanning for access points external to the wireless device, in accordance with operation of the wireless device as a station;
means for suppressing transmission of beacons while scanning until a number of suppressed beacons satisfies a threshold; and
means for halting the scanning and transmitting a beacon, in response to the number of suppressed beacons satisfying a threshold.
